(19) United States
(12) Patent Application Publication
(10) Pub. No.: US 2026/0200113 A1
(43) Pub. Date: Jul. 16, 2026

(54) SHAVING DEVICE WITH NOVEL BLADE RELEASE MECHANISM

(71) Applicants: DeShawn Spencer, Upland, CA (US); Brendon Hingston Lake, Venice, CA (US)

(72) Inventors: DeShawn Spencer, Upland, CA (US); Brendon Hingston Lake, Venice, CA (US)

(21) Appl. No.: 19/129,373

(22) PCT Filed: Nov. 17, 2023
(86) PCT No.: PCT/US2023/080310

§ 371 Date: May 13, 2025

Related U.S. Application Data
(60) Provisional application No. 63/384,432, filed on Nov. 20, 2022.

(51) Int. Cl. B26B 21/16; B26B 21/52

(52) U.S. Cl. CPC B26B 21/165; B26B 21/527

(57) ABSTRACT

A hand-held shaving device is disclosed. The device includes a blade carrier top and base that cooperate to secure a double-edge razor blade in place. These mount onto a shaver base that is designed to be held in the hand of a user. The device further comprises a novel mechanism that permits convenient installation and removal of the shaving blade. When assembled, the device provides rests that contact the body surface to be shaved and when in contact with the body surface set the razor blade at an optimal shaving angle. The process of shaving comprises contacting the body surface to be shaved and moving the device in the direction of the razor blade edge. The device is designed so that it can be used in either hand.

### CROSS-REFERENCE TO RELATED APPLICATIONS

This application claims the benefit of U.S. Provisional Application No. 63/384,432 filed Nov. 20, 2022, and entitled “HEAD SHAVING DEVICE WITH NOVEL BLADE RELEASE”, and U.S. Pat. No. 11,020,864, issued Jun. 1, 2021, and entitled “HEAD SHAVING DEVICE”, the entirety of each of which are hereby incorporated by reference in their entirety.

### FIELD OF THE INVENTION

This invention relates to shaving devices, in particular manual shaving devices using safety razor blades for personal grooming.

### BACKGROUND

Evidence of shaving devices dates to the Bronze age, with the oldest razor-like object dating to approximately 18,000 BC. Early forms of razors were fashioned from shells, obsidian and other materials that could be readily formed into an object having a sharp edge.

The first straight razors were developed in England in the 18^{th} and 19^{th} centuries. Typically, these were used by trained barbers to give their customers a quick and thorough shave. With the advent of the safety razor in 1901, it became more convenient for people to manage their own personal grooming, without the need for special training in the use of a shaving implement.

Since that time, several designs have been developed. In some the head is made to pivot to follow the contours of the part of the body being shaved. In others, shaving heads have been designed to hold two, three, or even more blades to allow shaving as closely as possible without breaking the skin.

It has been, and continues to be, fashionable for people to shave their heads. Shaving the head with conventional safety razors is problematic for several reasons, one of which being that the design of safety razor handles is such that they are optimized for manually shaving what could be thought of as vertically oriented surfaces, such as the face and legs. In prior art razor designs, the longitudinal axes of the handle and cutting portion are oriented substantially perpendicular to each other. While this provide a convenient orientation for shaving the face or legs, it is not optimal for shaving the head, which can be thought of as a horizontally oriented body surface.

There are prior art shaving designs intended for use in shaving the head. For example, U.S. Pat. No. 8,726,528 (Lyles) discloses a portable electric head shaver that includes a cutter head with rotating blades. However, this device is limited in that it is electrically powered thus requiring periodic replacement of batteries or a rechargeable battery. Similarly, the cutter head assembly is mechanically complex. Taken together, this shaver is expensive and difficult to manufacture.

Thus, what is needed is a mechanically simple shaver that is effective to allow a user to shave their head, or other curved body surfaces, which provides a convenient and efficient mechanism to install and remove blades.

### SUMMARY OF THE INVENTION

The present disclosure provides a novel hand-held shaving device that is mechanically simple and provides for comfortable and efficient shaving by setting the razor blade at an optimal angle relative to the body surface being shaved.

The invention comprises, in some embodiments, A shaving device for shaving a body surface, the shaving device comprising: a blade carrier assembly; a shaver base, the shaver base comprising: a mounting area configured to cooperatively receive the blade carrier assembly; and a channel sized and shaped to receive a finger on a hand of user; wherein the blade carrier assembly comprises an upper blade carrier and a lower blade carrier, the upper blade carrier and lower blade carrier configured to secure a safety razor blade in a fixed position, and to be reversibly mountable to the shaver base; wherein the upper blade carrier further comprises: at least one notched post, the at least one notched post sized and spaced to extend through a hole in a safety razor blade, and wherein the at least one notched post is further sized and spaced to extend through a hole formed in the lower blade carrier and into a hole formed in the shaver base, and wherein the at least one notched post is configured to secure the upper blade carrier and lower blade carrier to the shaver base; wherein the lower blade carrier is shaped to be complimentary to the upper blade carrier such that when the safety razor blade is secured between the upper blade carrier and lower blade carrier, the upper blade carrier exerts a force on the safety razor blade that is resisted by the lower blade carrier, and which results in flexion of the safety razor blade to a pre-determined angle and maintains the safety razor blade in a fixed position; wherein the shaving device further comprises a user manipulable mechanism configured to reversably secure the blade carrier assembly to the base of the shaving device that permits a user to install a fresh safety razor blade and then later remove a used safety razor blade from the shaving device; wherein the user manipulable mechanism comprises: at least one button, wherein the at least one button is sized and shaped to fit and be movable within at least one button guide, the at least one button guide formed in the underside of the lower blade carrier; wherein the at least one button comprises a catch, the catch configured to reversibly engage a notch formed on the at least one notched post located on the underside of the upper blade carrier; at least one bias force member, the at least one bias force member configured to be placed within the at least one button guide, and operative to exert sufficient force on the at least one button, such that the button is moved within the at least one button guide and engage the at least one notched post with sufficient force that the blade carrier assembly is secured to the base of the shaving device in a fixed position; wherein when assembled and in use, the shaving device is configured to orient an edge of the safety razor blade at an optimal angle relative to the body surface to be shaved.

In some embodiments, the upper blade carrier comprises two notched posts.

In some embodiments, the at least one button comprises an external button face and at least one internal button end, the at least one internal button end configured to contact and be acted upon by the at least one bias force member.

In some embodiments, the lower blade carrier comprises a pair of button guides each button guide oriented parallel to the other and both button guides oriented parallel to the long axis of the lower blade carrier.

In some embodiments, the user manipulable mechanism comprises two diametrically opposed buttons, each button moveable within the at least one button guide.

In some embodiments, the at least one bias force member is positioned between and contacts the at least one internal button end on each of the diametrically opposed buttons, such that the at least one bias force member is effective to push the buttons in opposite directions within the at least one button guide.

In some embodiments, the manipulable mechanism further comprises a pair of bias force members, wherein each of the pair of bias force member is positioned within each of the button guides.

In some embodiments, the at least one button comprises a pair of internal button ends, the pair of internal button ends separated by a notch, the notch configured to engage a center post, the center post formed in the underside of the lower blade carrier.

In some embodiments, the mounting area comprises a central portion and lateral portions, wherein each lateral portion further comprises a groove, the groove configured to receive a rail formed on the underside of the lower blade carrier.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numerals, and where:

FIG. 1 is an exploded perspective view of a prior art embodiment of a shaving device;

FIG. 2 is a perspective view of a prior art embodiment of an assembled shaving device;

FIG. 3 is a perspective view of an embodiment of an assembled shaving device according to the present disclosure;

FIG. 4 is an exploded view illustrating components of an embodiment of a shaving device according to the present disclosure;

FIG. 5 is perspective view of the underside of an embodiment of a lower blade carrier according to the present disclosure;

FIG. 6A is a top view of an embodiment of a button according to the present disclosure;

FIG. 6B is a side view of an embodiment of a button according to the present disclosure;

FIG. 6C is a bottom view of an embodiment of button according to the present disclosure;

FIG. 7A depicts components of an embodiment showing components of a lower blade carrier assembly according to the present disclosure;

FIG. 7B depicts an embodiment of a partially assembled lower blade carrier assembly showing placement of springs;

FIG. 7C depicts an embodiment of a partially assembled lower blade carrier assembly showing placement of springs and one upper blade carrier engagement button;

FIG. 7D depicts an embodiment of a fully assembled bottom blade carrier base assembly in a configuration ready to be secured to a shaver base;

FIG. 8A depicts a cross-sectional view of an embodiment according to the present disclosure, wherein the upper blade carrier is in a disengaged configuration; and

FIG. 8B depicts a cross-sectional view of an embodiment according to the present disclosure, wherein the upper blade carrier is in an engaged configuration.

### DETAILED DESCRIPTION OF THE INVENTION

The present invention provides a manual shaving device with a novel mechanism to permit quick and convenient exchange of a safety razor blade.

The following discussion provides examples of embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed. Those of skill in the art will recognize that the described embodiment are examples of possible configurations of the invention and are not intended to be limiting to the scope of the invention. Accordingly, the drawings and descriptions contained herein are to be regarded as illustrative of the invention as set forth in the accompanying claims.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

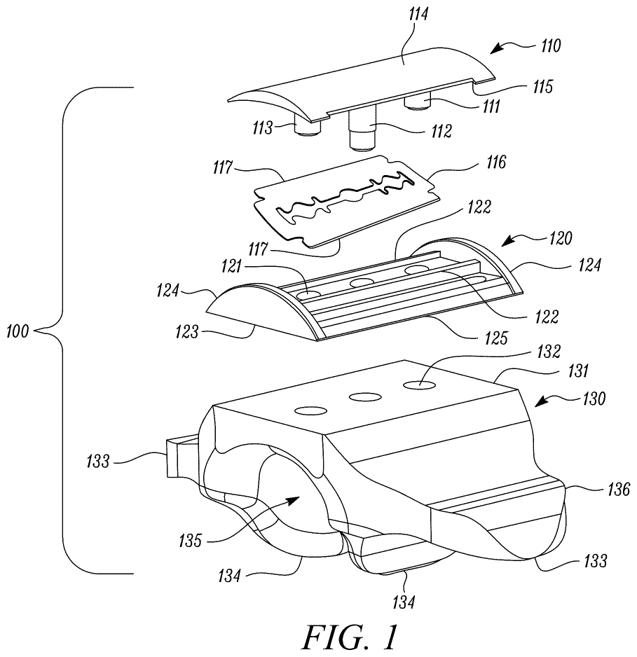

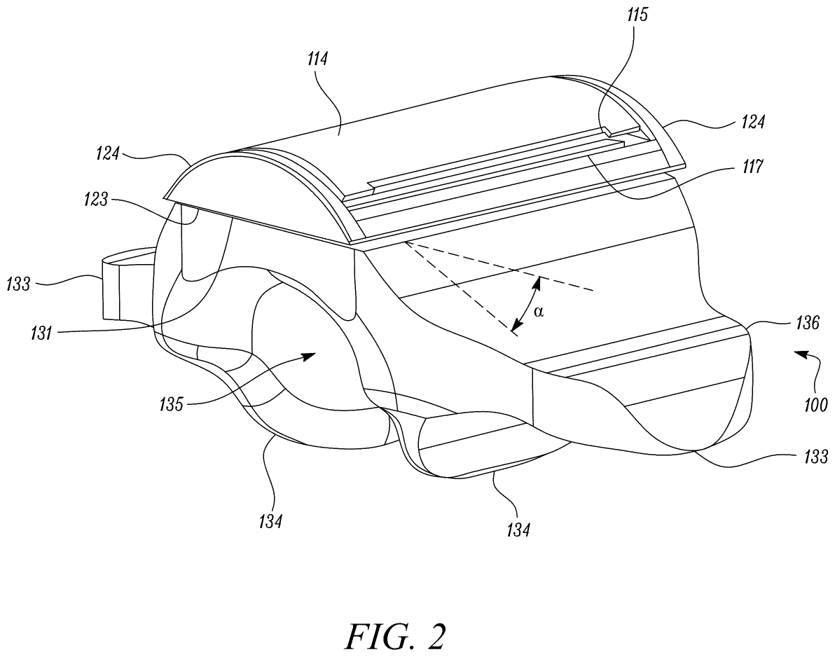

The present invention, as described herein and in the accompanying figures comprises a shaving device 100 adapted for shaving curved body surfaces, in particular the scalp. As shown in FIG. 1, an exploded view of a prior art embodiment of a shaving device 100 comprise three major components, a shaver base 130, a blade carrier base 120, and a blade carrier top 110. These, in cooperation with a double-edged safety razor blade 116, are effective to allow a user to shave with the sharpened edges 117 of the razor blade 116 set to an optimal angle (shown as “α” in FIG. 2) relative to the surface being shaved.

A blade carrier top 110 comprises a curved body 114, one or more mounting posts 111, 112, 113 and a notch 115 on either side of the blade carrier top 110. The corresponding notch on the opposite side is hidden in the perspective view shown in FIG. 1. The blade carrier top is configured to engage a blade carrier base 120. When the shaver is assembled and in the ready to use configuration, a razor blade 116 is sandwiched between the blade carrier top 110 and the blade carrier base 120, and the sharpened edges 117 of the razor blade are exposed by the notch 115.

The blade carrier base 120 comprises mounting holes 121 that receive the mounting posts 111, 112, 113, the mounting posts sized such that they extend through the safety razor blade 116, blade carrier base 120 and engage complimentary shaver base holes 132, located in the shaver base 130. The mounting posts may be sized to engage and be secured in the holes in the shaver base by friction, or optionally fasteners may be used to secure the assembled components of the shaving device.

The blade carrier base 120 has a flat undersurface 123 that mounts onto the upper shaver base surface 131 of the shaver base 130 as the shaving device is assembled for use. The blade carrier base further comprises upper curved end surfaces 124 that compliments the curved shape of blade carrier top body 114, such that when assembled the shaver has a snug and compact fit and appearance, as can be appreciated in FIG. 2. The complimentary curved shapes of the blade carrier top 110 and blade carrier base 120 are also effective to impart flexion on the safety razor blade when it is mounted.

The blade carrier base 120 further comprises blade rests 122, onto which the razor blade 116 will be placed prior to securing the razor blade 116 by placing the blade carrier top 110 onto the blade carrier base 120 and fully engaging the top and base as depicted in FIG. 2. When assembled, the razor blade 116 is substantially held in a fixed position, with the razor blade edges 117 exposed. A blade carrier rest 125 provides one point of contact with the body surface during shaving and cooperates with the shaver base rest 136 to set the razor blade at an optimal angle (shown as “α” in FIG. 2). In some embodiments the device can be configured such that the optimal angle is between about 15° and about 25°. In some embodiments, the optimal angle can be about 20°.

The shaver base 130 comprises an upper shaver base surface 131, which as indicated above receives the blade carrier base 120 portion of the device. Also as described above, the shaver base 130 comprises one or more shaver base holes 132, that are configured to receive and engage the posts 111, 112, 113 of the blade carrier top 110. The posts can be sized to fit snugly by friction into the shave base holes 132, or optionally, fasteners like those known in the art can be used to secure the blade carrier top to the shaver base 130 from the bottom of the device.

The shaver base 130 further comprises lateral extensions 133 that extend from the main body of the shaver base 130. These lateral extensions are shaped and sized to include shaver base rests 136, which as described above cooperate with the blade carrier rests 125 to set the razor blade at a predetermined angle when shaving.

The shaver base also comprises a tunnel 135, formed by complimentary lower extensions 134. In one embodiment, a user will insert their middle finger into the tunnel 135 and place their ring finger and index finger outside the tunnel 135 resting on the outer aspect of the lower extensions 134. In this way the shaving device can be held relatively securely and cradled on the palm side of the hand with three fingers providing stability during use. If preferred, the user may hold the device in other ways. The precise way in which the user manipulates the shaver is not limiting to the scope of the invention.

To begin shaving, the user will position the device so that a blade carrier rest 125 and the shaver base rest 136 located on the same side of the device rest upon the body surface to be shaved. The shaving device will then be moved by a user in the direction the corresponding razor blade edge 117 is facing in order to perform the shaving action. Conveniently, the shaving device is bilaterally symmetrical such that a user can place the shaver in either their right hand or left hand and achieve the same results when shaving.

Further, the device makes it easy to change razor blades when the one being used loses its edge and become too dull for comfortable shaving. To replace the blade 116, the user will simply disengage the blade carrier top 110 from the rest of the device, remove the used blade, place a new blade onto the blade carrier base and then reattach and secure the blade carrier top 110 to the blade carrier base 120.

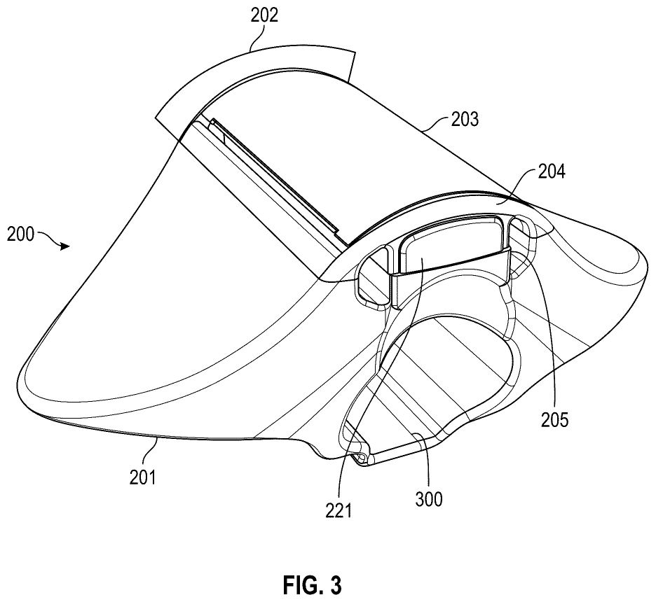

In yet another preferred embodiment depicted in FIGS. 3-8 inclusive, a shaving device 200 comprises a base 201, a blade carrier assembly 202, the blade carrier assembly comprised of an upper blade carrier 203, a lower blade carrier 204, and a novel release mechanism configured to permit a user to engage and disengage the upper blade carrier from the remaining portions of the shaving device in order to install a safety razor blade, and then subsequently remove the blade when it becomes worn and a fresh blade is desired to replace the worn blade.

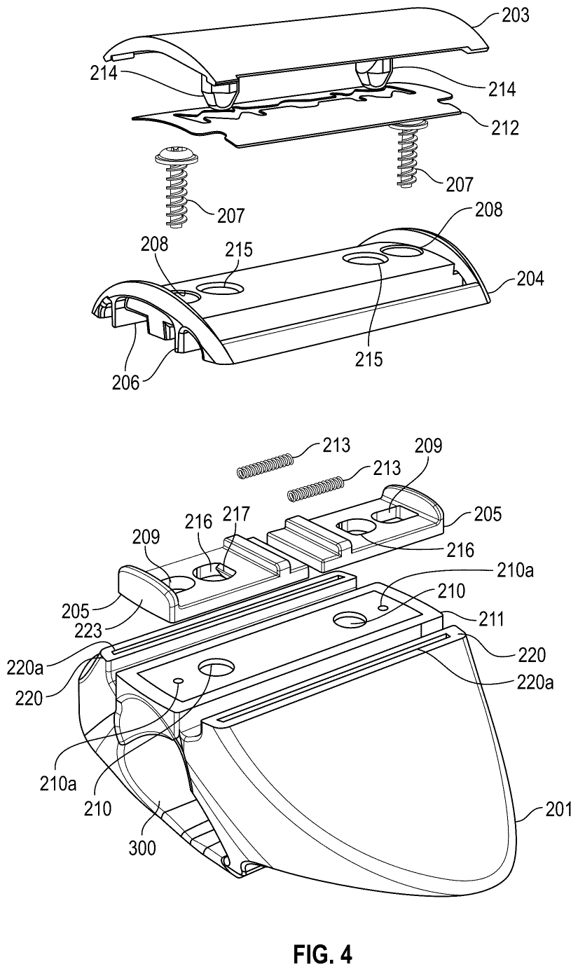

As shown in FIG. 4, which is a partially exploded view of an embodiment of a shaving device according to the present disclosure, the device comprises a base 201, an upper blade carrier 203, a lower blade carrier 204, buttons 205 oriented in a diametrically opposed configuration and generally parallel to an ergonomic channel 300. In some embodiments, the ergonomic channel 300 (functionally analogous to the tunnel 115 described above) may be in the form of an enclosed tube that completely encircles the user's finger. In other embodiments, the channel 300 may form a partial tube, or tunnel with a gap extending the length of the shaver positioned on the lowermost portion of the channel. The precise design of the channel is not limiting to the scope of the invention. The lower blade carrier 204 comprises button guides 206 that engage and orient the buttons 205, and which function as a track along which the buttons can be moved back and forth to engage and disengage the blade carrier assembly 202 from the shaving device, as well as to separate the upper blade carrier 202 from the lower blade carrier 203.

In assembling the shaving device, the lower blade carrier 204 and buttons 205 are held in place on mounting area of the shaver base (the mounting area comprising a central portion 211 and lateral portions 220) using screws 207 that extend through a first set of lower blade carrier holes 208 and a first button hole 209 and engage threads in fastener holes 210a formed in the base. The buttons 205 are placed so that they lie within a track formed by the button guides 206. In a preferred embodiment shown in FIG. 4, the lower blade carrier comprises a pair of first set of lower blade carrier holes 208, each hole positioned on either side of the centerline of the carrier, and further positioned to be in alignment with fastener holes 210a located in the central portion of the mounting platform 211. The central portion of the mounting platform 211 further comprises post holes 210 designed to provide space for the ends of the posts 214 to extend into when the device is assembled.

Bias force members 213 are positioned between the buttons and provide a bias force that operate to resistance inward movement of the buttons 205. In some embodiments bias force members 213 comprise springs or like components well known in the art.

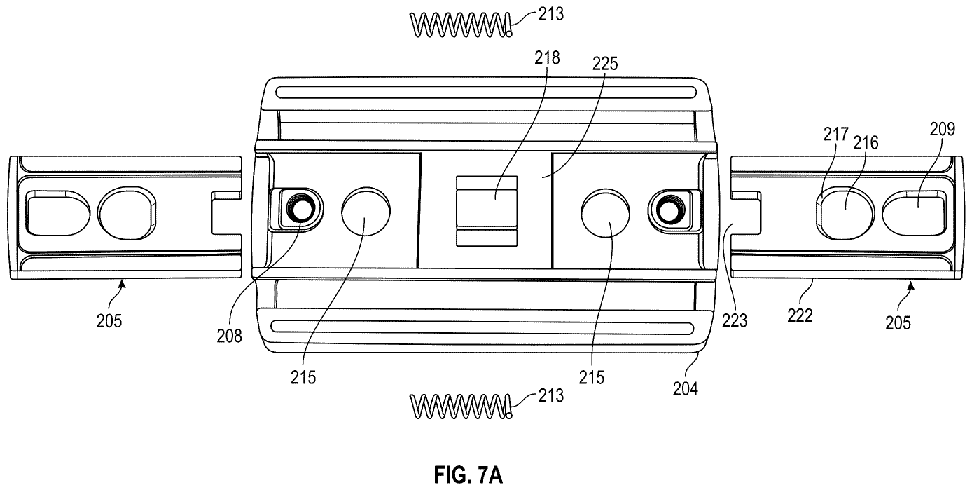

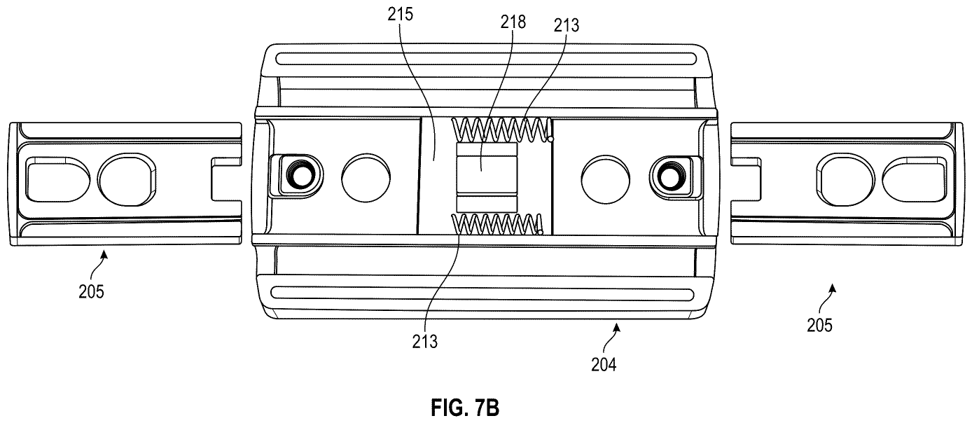

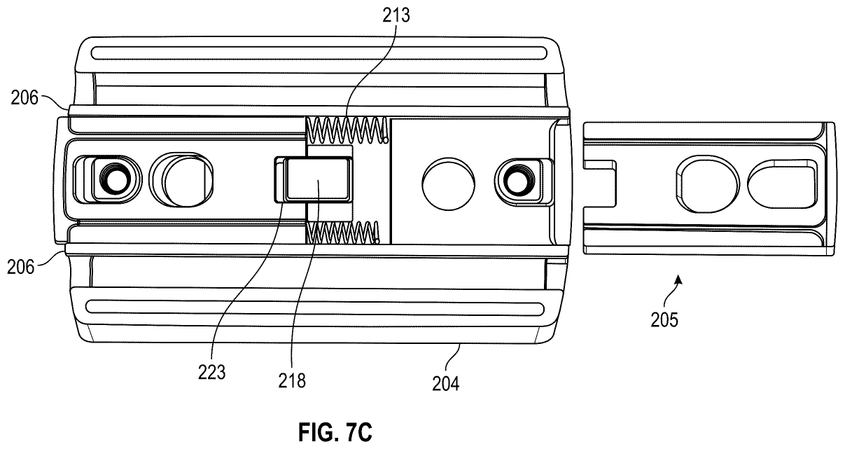

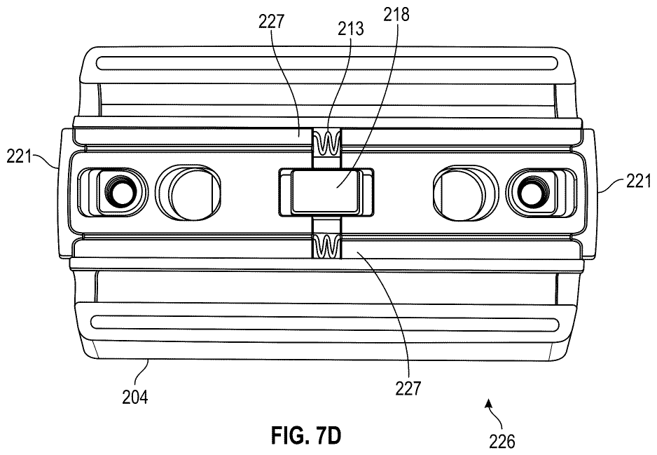

In the assembled shaving device, the buttons 205 are sandwiched between the lower blade carrier 204 and a mounting area, as described above the mounting area comprising a a central portion 211 and lateral portions 220 to which the lower blade carrier assemble is attached. This lower blade carrier assembly (see FIG. 7D) is secured in place to the base 201 with the fasteners 207 such that the lower blade carrier assembly is in a substantially fixed position on the mounting area central portion 211 and lateral portions 220 of the mounting area (See FIG. 4). Fasteners 207 can comprise screws or other like components well known in the art. In addition, the buttons 205 are sized such they are substantially free to move along the track formed by the button guides 206.

The upper blade carrier 203 is secured to the shaving device by notched posts 214 that are configured to extend through a second set of lower blade carrier holes 215 and engage catches 217 formed within a second button hole 216 formed in each button 205. A safety razor blade 212 is sandwiched between the upper blade carrier 203 and lower blade carrier 204 and maintained in a substantially fixed position relative to the base 201 when the components are fully assembled and the notched posts 214 of the upper blade carrier 203 engage catches 217 in the buttons 205. Conveniently, the shapes of the upper blade carrier 203 and lower blade carrier 204 are configured such that they cooperate to maintain the razor blade at an angle “α” (refer to FIG. 2) relative to the base 201 that has been determined to be optimal for shaving.

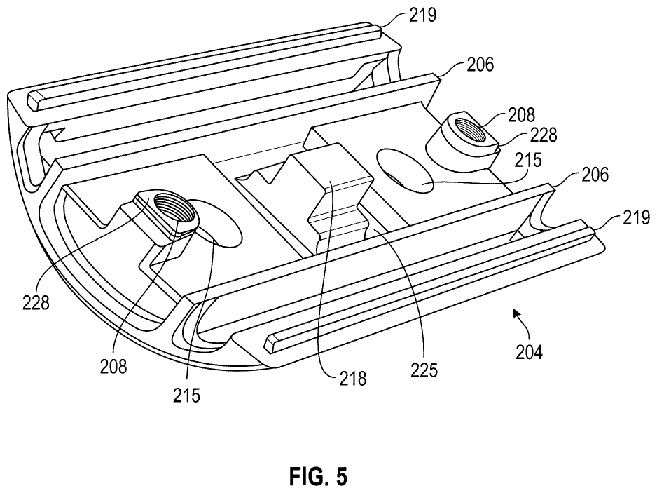

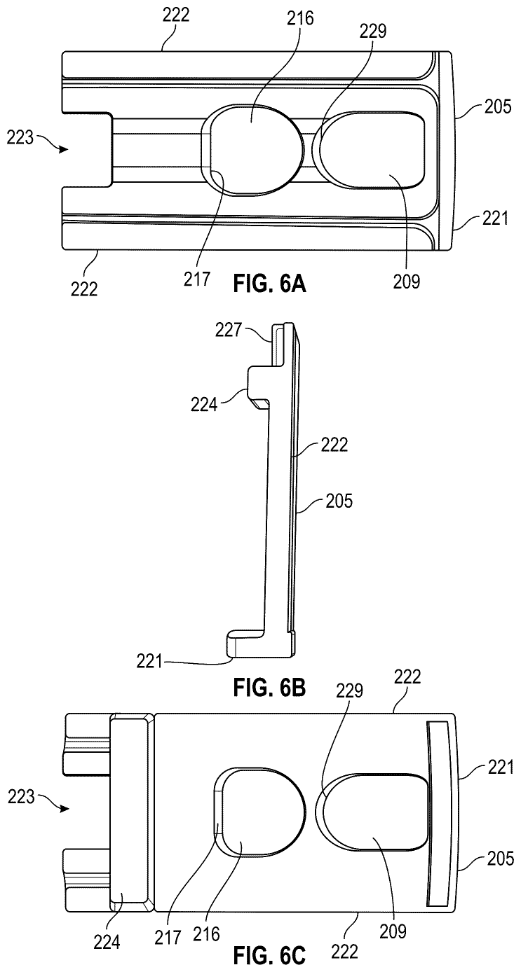

Referring now to FIG. 5, additional detail of the underside of the lower blade carrier 204 are shown. The lower blade carrier 204, in addition to the structures describe above, further comprises a center post 218. The center post 218 is shaped to slidably engage a button notch 223 (see FIGS. 6A and 6C) in each button 205 and to assist in maintaining the alignment and smooth operation of the buttons 205 within the button guides 206, as will be shown and described in later figures. The lower blade carrier 204 also comprises engagement rails 219 on either side of the carrier, these rails are configured to engage grooves 220a formed in each lateral portion 220 of the mounting platform, when the blade carrier assembly 202 is mounted to the shaver base 201 (See also FIG. 4). The rails and receiving surface cooperate in defining and maintaining the position of the lower blade carrier 204 relative to the shaver base 202.

FIGS. 6A-6C , inclusive, depict additional details of an embodiment of a button of the present disclosure. As described above, a button 205 has a first button hole 209 that is configured to allow a fastener 207 to extend through the button and into a fastener hole 210a in the central portion 211 of the mounting area. As can be seen in FIGS. 6A (a top view) and 6C (an underside view) the first button hole 209 is not round but forms an opening with an extended configuration. The shape is designed such that a button 205 can move relatively freely back and forth within the button guides 206, and so that when the device is assembled the fastener does not impede the sliding action of each button 205. Similarly, the shape of each first button hole 209 permits the button to slide freely back and forth relative to the end post 228 that extends through the first button hole 209 when the device is assembled.

As is shown in FIGS. 6A, 6B, and 6C, a button further comprises at one end an external button face 221, lateral button edges 222, and at the opposite end a button notch 223. As can be seen in FIGS. 3 and 4, the external button face of each button is oriented outwards from the body of the shaving device and accessible to a user. The lateral button edges 222 are sized and configured to fit within the button guides 206 formed in the lower blade carrier 204. The button notch 223 is sized to fit around a portion of the center post 218, and as described, to assist in maintaining the alignment of the button within the button guide and to limit the inward travel of the button 205 relative to the lower blade carrier 204. The button also includes an internal support 224 that, when the shaving device is being assembled fits into a space provide by the well 225 formed in the underside of the lower blade carrier 204.

FIGS. 7A-D depicts an embodiment of the various components and steps in assembling them into a lower blade carrier assembly 226 that can then be mounted on the base 201. The views presented in FIGS. 7A-D are from the underside of the lower blade carrier. The components include a lower blade carrier 204, two buttons 205, and two bias force members 213. In a first step in the assembly of these components, shown in FIG. 7B, the bias force members 213 are placed in the well 225 of the lower blade carrier 204, one on either side of the center post 218, and extending parallel to the long axis of the lower blade carrier 204.

In a next assembly step, one of the buttons 205 is placed between the button guides 206 so that a portion of the button notch fits on either side of the center post 218. The internal support 224 of the button is positioned within the well 225 (not shows in this Fig. as it lies on the opposite of the assembly as being depicted).

In a final assembly step, the remaining button is placed into the lower blade carrier in a substantially similar manner. As shown in FIG. 7D, the bias force members 213 are maintained in place by the cooperation of the two buttons, each comprising an overhang 227 that overlies the ends of the bias force members 213. The buttons 205 are prevented from escaping from the button guide 206 by virtue of an end post 228 (See FIG. 5), that restricts the outward range of movement of each button 205 as this end post 228 extends into its complimentary first button hole 209. The inward range of motion of the button is restricted by the button notch 223 moving relative to the center post 218, the center post 218 acting as a stop. Once assembled the lower blade carrier assembly can be mounted to the base 201 as described above. The force produced by the bias force members 213 operate to push each button outward until the inside edge 229 of the first button hole abuts the end post 228.

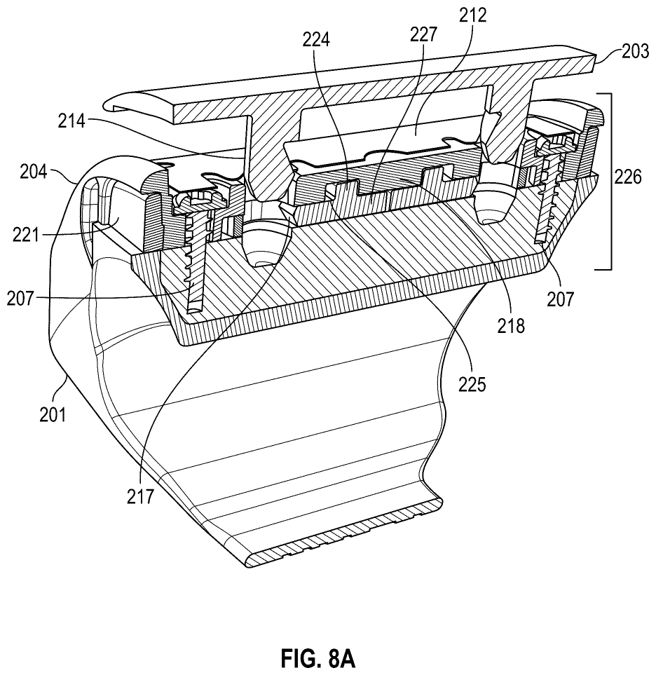

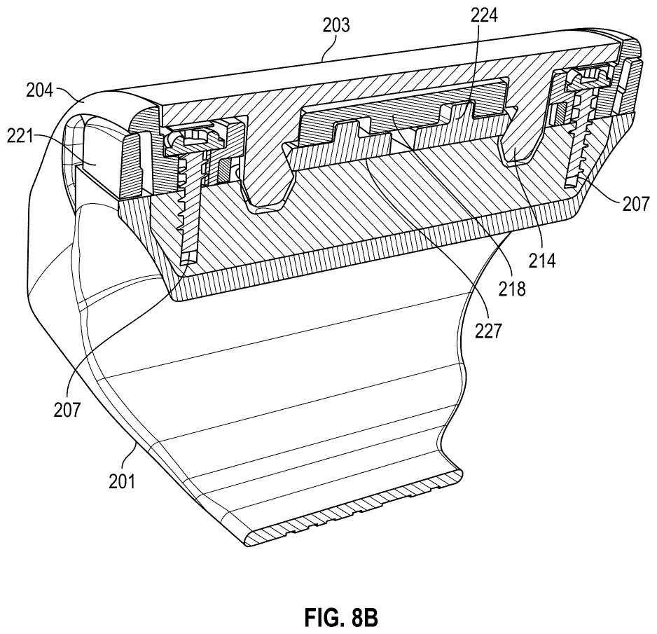

FIGS. 8A and 8B depict cross-sectional views of an embodiment of a shaving device in two configurations. In FIG. 8A the device is shown with the upper blade carrier 203 disengaged from the lower blade carrier assembly 226, which in this figure remains mounted to the base 201. Fig. B depicts an embodiment of a shaving device with the upper blade carrier 203 engaged and the shaving device in a fully assembled, ready for use, configuration.

To release the upper blade carrier 203 from the shaving device, a user applies pressure to the buttons 205 on either side of the device. This disengages the notched posts from the catches and allows the upper blade carrier to be separated from the rest of the shaving device. A new razor blade 212 can then be installed or a worn one removed. To reassemble the device, the buttons 205 are again pressed inwards, the upper blade carrier 203 positioned so that the notched posts 214 are inserted into the second set of lower blade carrier holes 215. Once in place, the buttons are released and the catches 217 in the buttons engage the notched posts to maintain the upper blade carrier in a substantially fixed position on the lower blade carrier assembly, which is in turn secured to the base.

Alternatively, rather than pushing the buttons prior to re-assembling the components a user can simply place a new blade into the upper blade carrier, align the posts 214 with the second set of lower blade carrier holes 215, then apply pressure by pushing downward on the upper blade carrier to overcome the bias force members such that the buttons are moved outwards, and the posts click into place by engaging the catches 217.

It will be apparent to those skilled in the art that many more modifications besides those already described are possible without departing from the inventive concepts herein. For example, it will be realized that the optimal dimensions for the various parts of the invention, materials, shape, form, manner of assembly, and operation or use will be apparent to those of skill in the art.

In terms of materials, a wide variety of materials may be used to fashion the components of the invention of the present disclosure. In some cases, the shaving device may be made of wood, plastic, metal, and combinations thereof. The components of the shaving device may also be secured together with the use of fasteners and/or adhesives of various kinds known in the art.

The inventive subject matter, therefore, is not to be restricted except in the scope of any appended claims. Moreover, in interpreting both the specification and the claims, all terms should be interpreted in the broadest possible manner consistent with the context. In particular, the terms “comprise(s)” and “comprising” should be interpreted as referring to elements, components, or steps in a non-exclusive manner, indicating that the referenced elements, components, or steps may be present, or utilized, or combined with other elements, components, or steps that are not expressly referenced. All suitable modifications and equivalents that may be resorted to are thereby considered to be within the scope of the present invention.

What is claimed is:

1. A shaving device for shaving a body surface, the shaving device comprising:
a blade carrier assembly;
a shaver base, the shaver base comprising:
a mounting area configured to cooperatively receive the blade carrier assembly; and
a channel sized and shaped to receive a finger on a hand of user;
wherein the blade carrier assembly comprises an upper blade carrier and a lower blade carrier, the upper blade carrier and lower blade carrier configured to secure a safety razor blade in a fixed position, and to be reversibly mountable to the shaver base;
wherein the upper blade carrier further comprises:
at least one notched post, the at least one notched post sized and spaced to extend through a hole in a safety razor blade, and wherein the at least one notched post is further sized and spaced to extend through a hole formed in the lower blade carrier and into a hole formed in the shaver base, and wherein the at least one notched post is configured to secure the upper blade carrier and lower blade carrier to the shaver base;
wherein the lower blade carrier is shaped to be complimentary to the upper blade carrier such that when the safety razor blade is secured between the upper blade carrier and lower blade carrier, the upper blade carrier exerts a force on the safety razor blade that is resisted by the lower blade carrier, and which results in flexion of the safety razor blade to a pre-determined angle and maintains the safety razor blade in a fixed position;
wherein the shaving device further comprises a user manipulable mechanism configured to reversably secure the blade carrier assembly to the base of the shaving device that permits a user to install a fresh safety razor blade and then later remove a used safety razor blade from the shaving device;
wherein the user manipulable mechanism comprises:
at least one button, wherein the at least one button is sized and shaped to fit and be movable within at least one button guide, the at least one button guide formed in the underside of the lower blade carrier;
wherein the at least one button comprises a catch, the catch configured to reversibly engage a notch formed on the at least one notched post located on the underside of the upper blade carrier;
at least one bias force member, the at least one bias force member configured to be placed within the at least one button guide, and operative to exert sufficient force on the at least one button, such that the button is moved within the at least one button guide and engage the at least one notched post with sufficient force that the blade carrier assembly is secured to the base of the shaving device in a fixed position;
wherein when assembled and in use, the shaving device is configured to orient an edge of the safety razor blade at an optimal angle relative to the body surface to be shaved.

2. The shaving device of claim 1, comprising two notched posts.

3. The shaving device of claim 1, wherein the at least one button comprises an external button face and at least one internal button end, the at least one internal button end configured to contact and be acted upon by the at least one bias force member.

4. The shaving device of claim 3, wherein the lower blade carrier comprises a pair of button guides each button guide oriented parallel to the other and both button guides oriented parallel to the long axis of the lower blade carrier.

5. The shaving device of claim 4, wherein the user manipulable mechanism comprises two diametrically opposed buttons, each button moveable within the at least one button guide.

6. The shaving device of claim 5, wherein the at least one bias force member is positioned between and contacts the at least one internal button end on each of the diametrically opposed buttons, such that the at least one bias force member is effective to push the buttons in opposite directions within the at least one button guide.

7. The shaving device of claim 6, further comprising a pair of bias force members, wherein each of the pair of bias force member is positioned within each of the button guides.

8. The shaving device of claim 2, wherein the at least one button comprises a pair of internal button ends, the pair of internal button ends separated by a notch, the notch configured to engage a center post, the center post formed in the underside of the lower blade carrier.

9. The shaving device of claim 1, wherein the mounting area comprises a central portion and lateral portions, wherein each lateral portion further comprises a groove, the groove configured to receive a rail formed on the underside of the lower blade carrier.
